(19) United States
(12) Patent Application Publication
(10) Pub. No.: US 2025/0144530 A1
(43) Pub. Date: May 8, 2025

(54) MULTI-FACTOR CROSS PLATFORM TRANSACTION IDENTIFICATION

(71) Applicant: idPair, Inc., Morristown, NJ (US)

(72) Inventors: Jonathan Christy Aiwazian, Morristown, NJ (US); Karl Henrik Engstroem, Boulder, CO (US); James Matthew Powers, Ridgewood, NJ (US)

(21) Appl. No.: 18/940,010

(22) Filed: Nov. 7, 2024

Related U.S. Application Data
(60) Provisional application No. 63/596,714, filed on Nov. 7, 2023.

(51) Int. Cl. A63F 13/71; A63F 13/30; G06F 21/60; G06F 21/62

(52) U.S. Cl. CPC A63F 13/71; A63F 13/30; G06F 21/602; G06F 21/606; G06F 21/6254

(57) ABSTRACT

A method for providing multi-factor cross platform transaction identification. The method includes receiving, via a data bridge, gaming session data from at least one gaming platform of the plurality of gaming platforms, the gaming session data including identity information of a user associated with the gaming session data, transmitting, via a data analysis subsystem, a first security string to the data bridge, safeguarding, via the data bridge, the identity information of the gaming session data with the first security string to create safeguarded identity information, transmitting, via the data bridge, the safeguarded identity information and the gaming session data to the data analysis subsystem, and further safeguarding, via the data analysis subsystem, the safeguarded identity information of the gaming session data with a second security string to create a unique identifier.

### CROSS-REFERENCE TO RELATED APPLICATIONS

This Application claims the benefit of U.S. Provisional Application 63/596,714 filed on Nov. 7, 2023.

### TECHNICAL FIELD

This specification relates to multi-factor transaction identification and, in particular, to providing secure, confidential identifications across multiple gaming platforms.

### BACKGROUND

Online gaming (or gambling) platforms facilitate the betting or wagering money on various games of chance and skill. These platforms offer a wide range of games, including casino games like slots, poker, and blackjack, sports betting, lotteries, and more. Online gaming has become increasingly popular due to its convenience and accessibility, enabling users to play from the comfort of their homes or on the go. Such gaming platforms utilize user identification techniques to verify the age and/or location of players, ensuring the user meets the legal requirements in their jurisdiction. Additionally, user identification enhances the overall security of online gaming platforms. In some cases, user identification is also used to enable responsible gambling features, anti-money laundering features, fraud prevention, and/or sports integrity. By confirming the identity of users, online gaming platforms can offer tools to help individuals manage their gambling habits.

### SUMMARY

At least one aspect of the present disclosure is directed to a method for providing multi-factor cross platform transaction identification. The method includes communicating, via a data bridge, with a plurality of gaming platforms, communicating, via the data bridge, with a data analysis subsystem, receiving, via a data bridge, gaming session data from at least one gaming platform of a plurality of gaming platforms, the gaming session data including identity information of a user associated with the gaming session data, transmitting, via the data analysis subsystem, a first security string to the data bridge, safeguarding the identity information of the user of the gaming session data, via the data bridge, using the first security string to create safeguarded identity information, transmitting, via the data bridge, the safeguarded identity information and the gaming session data to the data analysis subsystem, and hashing, via the data analysis subsystem, and further safeguarding, via the data analysis subsystem, the safeguarded identity information of the gaming session data using a second security string to create a unique identifier.

A system for providing multi-factor cross platform transaction identification protection and transaction analysis, comprising: a data bridge configured to communicate with a plurality of gaming platforms; a data analysis subsystem configured to communicate with the data bridge; at least one memory; and at least one processing unit for executing computer-executable instructions stored in the memory, wherein the instructions, when executed, instruct the at least one processing unit to: receive, via the data bridge subsystem, gaming session data from at least one gaming platform of the plurality of gaming platforms, the gaming session data including identity information of a user associated with the gaming session data; transmit, via the data analysis subsystem, a first security string to the data bridge; safeguard, via the data bridge, the identity information of the gaming session data with the first security string to create safeguarded identity information; transmit, via the data bridge, the safeguarded identity information, and the gaming session data to the data analysis subsystem; and further safeguard, via the data analysis subsystem, the safeguarded identity information of the gaming session data with a second security string to create a unique identifier.

A method for providing cross platform transaction limit settings, comprising: receiving gaming session data from at least one gaming platform of a plurality of gaming platforms, the gaming session data including identity information of a user associated with the gaming session data; retrieving a universal limit setting associated with the user based on the identity information; comparing the gaming session data to the universal limit setting; and determining an adjusted limit setting based on at least one result of the comparison.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a block diagram of a gaming analysis system in accordance with aspects described herein;

FIG. 2 is a flow diagram of a method for providing multi-factor cross platform transaction identification in accordance with aspects described herein;

FIG. 3 is a diagram illustrating a data protection hierarchy in accordance with aspects described herein;

FIG. 4 is flow diagram of a method for determining user limits in accordance with aspects described herein; and

FIG. 5 is a block diagram of an example computer system in accordance with aspects described herein.

### DETAILED DESCRIPTION

Online gaming (or gambling) platforms facilitate the betting or wagering money on various games of chance and skill. These platforms offer a wide range of games, including casino games like slots, poker, and blackjack, sports betting, lotteries, and more. In most cases, online gaming platforms are accessed by users via an application or website. Such gaming platforms utilize user identification techniques to verify the age and/or location of players, ensuring they meet the legal requirements in their jurisdiction. Users typically need to create an account by providing personal information, such as their name, age, and payment details, which allows them to deposit and withdraw funds and keep track of their gaming activities.

These online gaming platforms often provide responsible gambling tools, allowing users to set deposit limits, self-exclude, or seek help for problem gambling. Users may manually set limits (e.g., deposit limits) to control or maintain their own gaming activity. In some cases, it may be beneficial for gaming platforms to automatically trigger limits (e.g., deposit limits) based on an individual user's gaming activity. However, online gaming users often have accounts spread across different platforms. As such, it can be difficult to monitor an individual's full gaming activity, given that each platform only has the ability to monitor the individual's activity within their own platform. In addition, it may be beneficial to confidentially analyze cross-platform gaming activity of users for regulatory and/or public policy purposes. An impediment to being able to confidentially analyze particular user's cross-platform gaming activity is the different format of the identification information used to create user accounts in the different gaming platforms. While similar identification information, such as name, address, email addresses, cell phone numbers, account information, and the like may be used, how the format of the identification information may differ from one gaming platform to another is also addressed.

Accordingly, systems and methods for providing multi-factor cross platform transaction identification are provided herein. In at least one embodiment, a gaming analysis system may includes a data bridge configured to communicate with a plurality of gaming platforms and a data analysis subsystem configured to communicate with the data bridge. The data bridge receives gaming session data from at least one gaming platform of the plurality of gaming platforms. In some examples, the gaming session data includes identity information of a user associated with the gaming session data. The data analysis subsystem transmits a first security string to the data bridge and the data bridge safeguards the identity information (e.g., encrypts via, for example, a hash function or the like, or obfuscates via randomizing data or the like) of the gaming session data with the first security string to create hashed identity information. Then, the data bridge transmits the safeguarded identity information and the gaming session data to the data analysis subsystem and the data analysis subsystem further safeguards (e.g., via another hash function or the like) the safeguarded identity information of the gaming session data with a second security string to create a unique identifier. In some examples, the unique identifier is used to analyze and monitor gaming behavior in a secure, confidential manner.

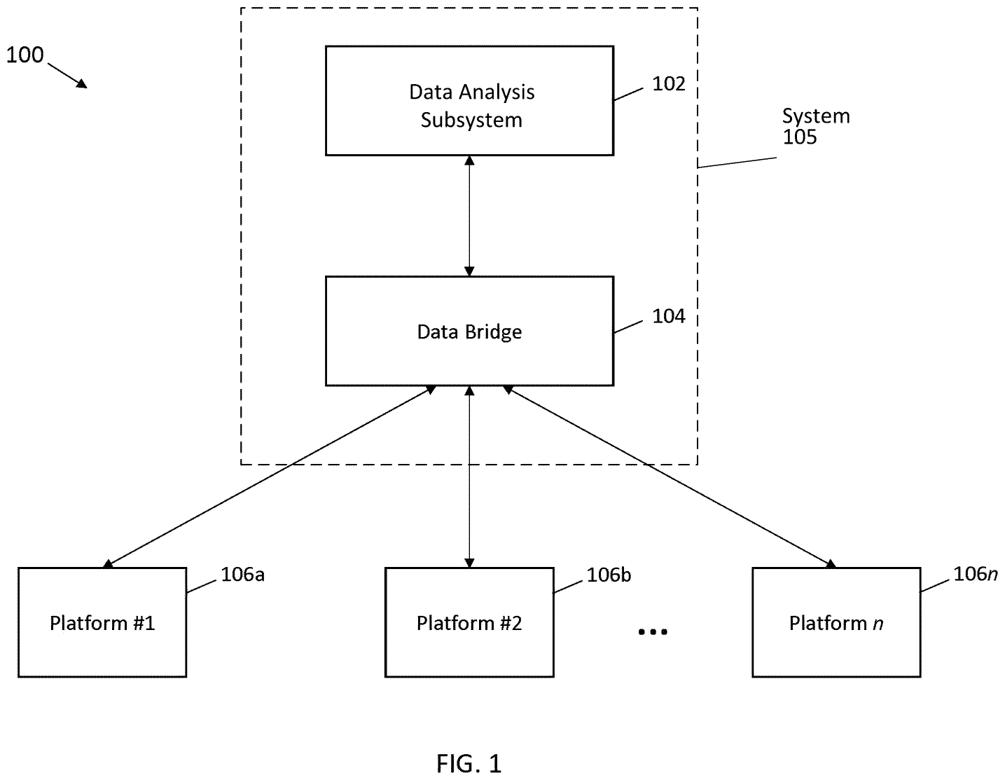

FIG. 1 is a block diagram of a gaming analysis system 100 in accordance with aspects described herein. A shown, the gaming analysis system 100 includes a gaming data analysis system 105 and a plurality of gaming platforms 106a-n. The gaming analysis system 105 may include a data analysis subsystem 102 and a data bridge 104. The data analysis subsystem 102 is configured to communicate with the data bridge 104 (e.g., over a wired or wireless network connection). The data bridge 104 is configured to communicate with the data analysis subsystem 102 and a plurality of gaming platforms 106 (e.g., over a wired or wireless network connection). In some examples, the data analysis subsystem 102 and the data bridge 104 are software algorithms implemented on one or more servers. In other examples, the data analysis subsystem 102 and the data bridge 104 are hardware devices (as described in a later example) operable to perform the functions described herein in cooperation with one another and the plurality of gaming platforms 106). The plurality of gaming platforms 106 correspond to online gaming platforms (e.g., FanDuel®, DraftKings®, MGM®, Caesars®, and the like). In some examples, the data analysis subsystem 102 and/or the data bridge 104 are implemented using multi-party computing. In an example, multi-party computing may be processes by which the respective gaming platforms cooperate with one another without exposing private data of common gaming platform users, such as different aspects of identifying information held by the respective gaming platforms of the multiple gaming platforms. The multi-party computing protects the common gaming platform user's identification information but still enables the system 100 to execute data evaluation processes without revealing private data to or receiving private data from the respective gaming platforms.

The data bridge 104 is configured to receive gaming session data from each gaming platform of the plurality of gaming platforms 106. In some examples, a gaming session corresponds to an irregular period of time (e.g., the time between a user opening and closing the application, the time between a user visiting and leaving the website, or the like.). In other examples, a gaming session corresponds to a regular period of time (e.g., a day, a week, a month, or the like). In some examples, the gaming session data includes the type of each transaction (or wager) placed, the quantity of transactions placed, the amount of each transaction, the result of each transaction, the times at which each transaction was placed, or any combination of thereof. In some examples, the gaming session data includes pre-existing, user-specific limits (or restrictions) that are associated with the user (e.g., deposit limits, wager limits, or the like). In some examples, the gaming session data includes pre-existing, platform-specific limits (or restrictions). In some examples, the gaming session includes personally identifiable information (PII) associated with the gaming platform user (e.g., the owner of the gaming account). For example, the PII may include the user's name (e.g., full name, last name, or the like), the user's date of birth, a portion of the user's social security number (e.g., the last four digits) or the user's full social security number, and/or a different identifier (e.g., a government issued identifier, such as a driver's license number). In some examples, the gaming session data includes different types of PII (e.g., a username, account number, banking information, or the like).

The data bridge 104 operates as an intermediary between the data analysis subsystem 102 and the plurality of gaming platforms 106 to provide data privacy and security. The data bridge 104 may be configured to inspect the incoming gaming session data and PII, and generate a first factor of data protection, or safeguarding, such that the PII of the users associated with the gaming session data is unknown to the data analysis subsystem 102. In some examples, the data analysis subsystem 102 is configured to transmit (or otherwise provide) a first security string (e.g., a first pepper, or first secret key) that is used to safeguard the PII included in (or with) the gaming session data. As such, the safeguarded PII may be obfuscated (e.g., rearranged data or altered PII data containing random dummy data) or encrypted, such as hashing, (or both obfuscated and encrypted) and the gaming session data can be transmitted (or otherwise provided) to the data analysis subsystem 102 without revealing the raw PII to the data analysis subsystem 102.

The data analysis subsystem 102 provides a second factor of data protection to further protect the PII of the users associated with the gaming session data. In some examples, the data analysis subsystem 102 is configured to further safeguard (e.g., randomize or hash) (i.e., second safeguarded) the already safeguarded PII (i.e., first safeguarded PII) received with the gaming session data using a second security string (e.g., a second pepper, or second secret key) to provide a further layer of safeguarded PII that is obfuscated or encrypted PII. In an operational example, the data analysis subsystem 102, after receiving PII that was safeguarded using a first hash function from the data bridge 104, is operable to apply further safeguards, via, for example, a second hash function to the already hashed PII, and analyze the gaming session data with the double-hashed PII. As such, the analysis is performed while maintaining confidentiality and anonymity of the individual users (or players) of the plurality of gaming platforms 106. In addition, reports, studies, surveys, and the like may be generated from the analysis of the gaming session data without the risk of traceability back to individual users. In an operational multi-party computing (MCP) example, the data bridge 104 is operable to facilitate the communication between the gaming platforms for the purposes of the MCP. Generally, a trusted third party is not needed for MCP, but we would insert ourselves to perform the math/encryption between the parties. Each party has to perform an action on the data and send it to the next in line, so we would allow them to input the data, where the data bridge would perform the action locally and facilitate the transmission to the next. At the end of the chain, it would be stored in our servers, where the information sought can be accessed by each party.

In an example, the identity information, such as PII, received from each gaming platform is consistent in content and format. This allows a common safeguarding process, like a hash function, to generate matching unique identifiers for the gaming session data received from the different platforms. Otherwise, the hashes will not match. The data bridge 104 is operable to receive the gaming session data and perform the formatting of the identity information, but, for example, an element of the identity information should match. For example, the last name provided in the identity information must match. If a gaming platform user changes their name or other input, a new hash is to be created. In some examples, the data bridge 104 is operable to validate the formatting but not the name itself.

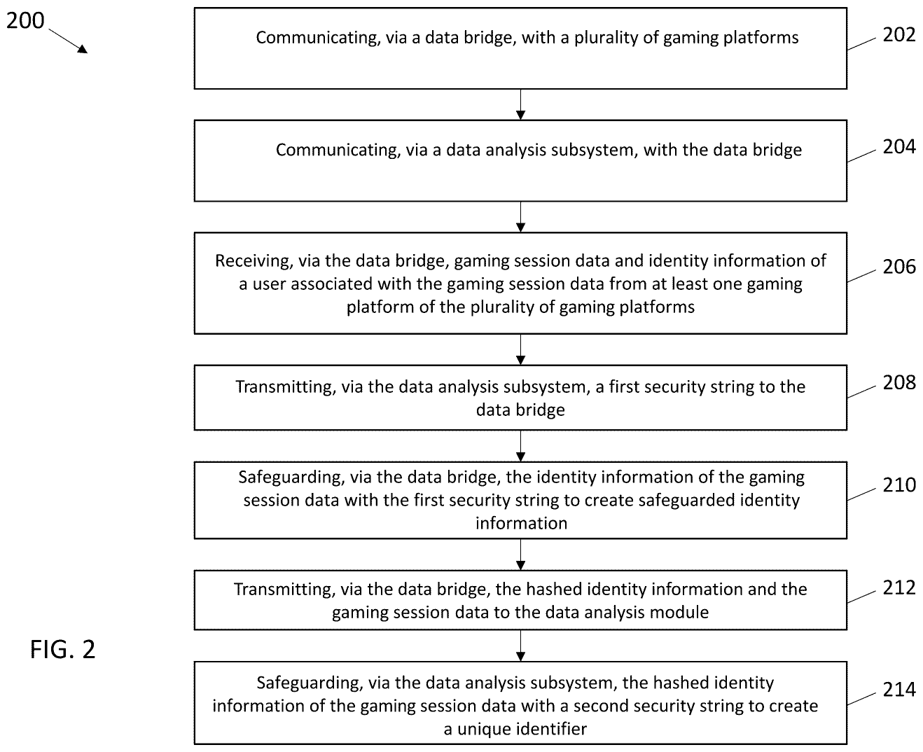

FIG. 2 is a flow diagram of a method 200 for providing multi-factor cross platform transaction identification in accordance with aspects described herein. In some examples, the method 200 is implemented as a computer-executable algorithm used to generate a secure, confidential unique identifier corresponding to an individual user of one or more gaming platforms of the respective gaming platforms 106.

At block 202, a data bridge (e.g., data bridge 104) communicates with one or more gaming platforms. As described above, the data bridge 104 is configured to communicate with a number of gaming platforms (e.g., the plurality of gaming platforms 106). In some examples, the data bridge 104 is provided as a software module instantiated on one or more servers, where a processor (shown in a later example) is configured to execute the computer executable algorithm to implement the functions of the data bridge.

At block 204, a data analysis subsystem (e.g., data analysis subsystem 102) is provided. As described above, the data analysis subsystem 102 is configured to communicate with the data bridge 104.

At block 206, the data bridge 104 receives gaming session data from at least one gaming platform of the plurality of gaming platforms 106. In some examples, the gaming session data includes identity information (e.g., PII) of a user associated with the gaming session data (e.g., the owner of the account(s) associated with the gaming session data). In some examples, the received gaming session data includes multiple gaming sessions from multiple respective gaming platforms of the plurality of gaming platforms 106. In some examples, the identity information is embedded within the gaming session data. In some examples, the identity information corresponds to a tag or label provided with the gaming session data. It should be appreciated that the gaming session data can include data associated with a plurality of users (e.g., the gaming session data with PII may be received in a batch of gaming session data).

In some examples, the data bridge 104 receives the gaming session data in an ad hoc manner. For example, when a user completes a gaming session, the gaming session data may be automatically pushed to the data bridge 104. In other examples, the data bridge 104 receives the gaming session data at periodic intervals. For example, each gaming platform 106a-n may automatically push gaming session data to the data bridge 104 at a regular interval (e.g., every hour, every day, every week, or the like). In some examples, the data bridge 104 receives gaming session data from the plurality of gaming platforms 106 in response to sending a request to the respective gaming platforms.

At block 208, the data analysis subsystem 102 transmits a first security string (e.g., a first pepper, or a first secret key) to the data bridge 104. In some examples, the first security string is a random string. In some examples, the data analysis subsystem 102 transmits the first security string in response to a request received from the data bridge 104. In other examples, the data analysis subsystem 102 transmits the first security string at a periodic interval (e.g., every day, every week, o.). In some examples, the data analysis subsystem 102 is configured to update (or regenerate) the first security string by request and/or periodically. In some examples, the data analysis subsystem 102 transmits a plurality of first security strings to the data bridge 104.

At block 210, the data bridge 104 safeguards the identity information (also referred to as “PII” and “identification information,” which are used interchangeably). For example, the data bridge 104 when safeguarding the identity information may be configured to utilize a hash function that hashes the identity information of the gaming session data with the first security string to create hashed identity information. In some examples, the data bridge 104 is configured to use a hashing function or algorithm (e.g., Argon2, or the like) to perform the hashing of the identity information. In an example, the hashing process may include combining the first initial of the user, the last name of the user, the last four digits of the user's social security number, the user's date of birth, and the first security string. In other examples, more or less identity information may be provided to the hash function or algorithm. In some examples, the data bridge 104 uses the same security string to hash the identity information received from each gaming platform 106a-n. For example, the same identity information is obtained from each of the plurality of gaming platforms 106 coupled to the data bridge 104. In other examples, when multiple security strings are provided by the data analysis subsystem 102, the data bridge 104 may allocate different security strings to different gaming platforms. In some examples, the data bridge 104 stores the identity information and the hashed identity information pair in a database (or look-up table). Such a database may be an internal or external database.

At block 212, the data bridge 104 transmits the hashed identity information and the gaming session data to the data analysis subsystem 102. In some examples, the data bridge 104 transmits the hashed identity information and the gaming session data in response to a request received from the data analysis subsystem 102. In other examples, the data bridge 104 transmits the hashed identity information and the gaming session data at a periodic interval (e.g., every day, every week, or the like).

At block 214, the data analysis subsystem 102 hashes the hashed identity information of the gaming session data with a second security string to create a unique identifier. In some examples, the data analysis subsystem 102 is configured to use, for example, a hashing algorithm (e.g., the same algorithm used in block 210 or a different algorithm) to perform the hashing of the hashed identity information. In some examples, the data analysis subsystem 102 is configured to generate the second security string. In other examples, the data analysis subsystem 102 is configured to receive the second security string (e.g., by request or periodically). In some examples, the data analysis subsystem 102 receives the second security string from a different software module (e.g., the data bridge 104, a third-party source, or the like). Like the first security string, the second security string may be updated (or regenerated) by request or periodically. In some examples, the data analysis subsystem 102 stores the hashed identity information and the unique identifier pair in a database (or look-up table). Such database may be an internal or external database.

In some cases, the identity data may have greater than 2 safeguarding procedures applied. For example, the data bridge 104 may apply 2 or more rounds of hashing algorithms to the identity information before forwarding the safeguarded identity information to the data analysis subsystem 102. The data analysis subsystem 102 may be operable to apply yet further safeguarding by, for example, applying one or more rounds of hashing algorithms to the already safeguarded identity information.

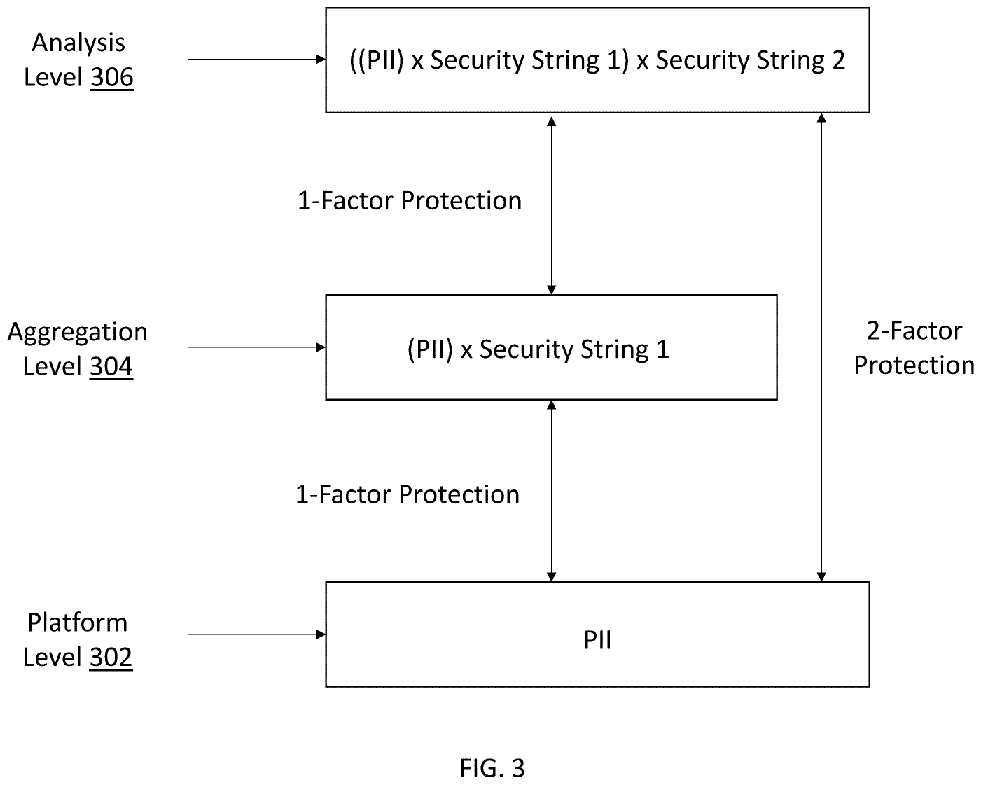

By providing multi-factor identification prior to performing data analysis, the identities of the individual users remain protected and confidential. For example, FIG. 3 illustrates the hierarchy of protection levels used by the gaming analysis system 100 of FIG. 1 and the method 200 of FIG. 2. The platform level 302 corresponds the operational level of the plurality of gaming platforms 106. As described above, the platforms 106 may use PII of each user to facilitate gaming transactions. The aggregation level 304 corresponds to the operational level of the data bridge 104. The data bridge 104 hashes the PII information received from the plurality of gaming platforms 106 with a first security string (“Security String 1”). As such, 1-factor of protection is provided between the operational levels of the data bridge 104 and the plurality of gaming platforms 106. The analysis level 306 corresponds to the operational level of the data analysis subsystem 102. The data analysis subsystem 102 hashes the hashed PII information (“(PII)×Security String 1”) received from the data bridge 104 with a second security string (“Security String 2”). As such, 1-factor of protection is provided between the operational levels of the data analysis subsystem 102 and the data bridge 104, while 2-factor protection is provided between the operational levels of the data analysis subsystem 102 and the plurality of gaming platforms 106.

While the examples above describe the use of a first and second security string to perform two level of data hashing, it should be appreciated that three or more security strings may be used to perform three or more levels of data hashing. For example, a third security string may be used to hash data at the aggregation level 304 (e.g., the operational level of the data bridge 104) or at the analysis level 306 (e.g., the operational level of the data analysis subsystem 102). In some examples, additional security strings may be used at different operational levels (e.g., above the data analysis subsystem 102, between the data analysis subsystem 102 and the data bridge 104, below the data bridge 104, or the like).

In some examples, the data analysis subsystem 102 is configured to analyze the confidential gaming session data for regulatory and/or public policy purposes. In such examples, the results of the analysis may be compiled into a report, survey, presentation, or the like that is delivered to a government agency, regulatory agency, or some other third-party. By concealing the identity of the users through multi-factor protection, such results can be displayed and/or studied without the risk of traceability back to individual users.

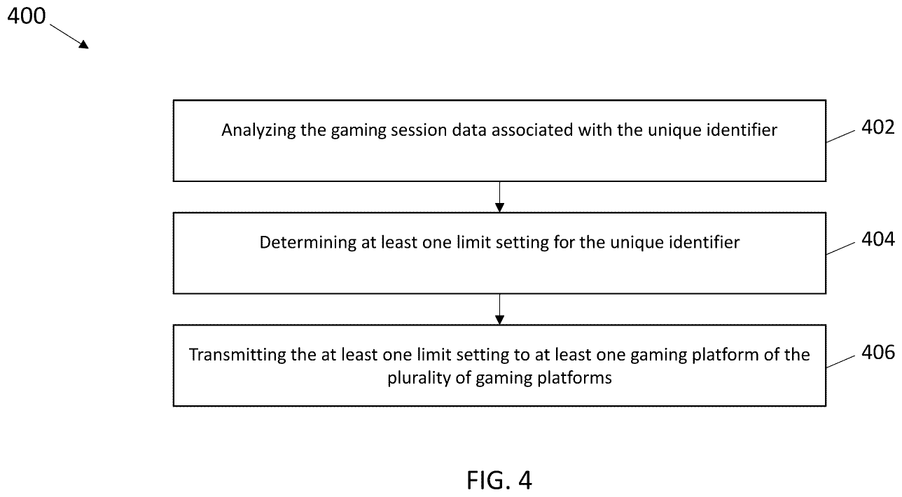

In some examples, the data analysis subsystem 102 is configured to analyze the confidential gaming session data to determine limits that are applied to individual users via the gaming platforms 106. FIG. 4 illustrates a flow diagram of a method 400 for determining user limits. The user limits may be transmitted back to the plurality of gaming platforms 106. In some examples, the method 400 is configured to be performed, at least in part, by the gaming analysis system 100 of FIG. 1. While the method 400 is described with respect to one user (i.e., one unique identifier), it should be appreciated that the method 400 may be performed with a plurality of users (i.e., a plurality of unique identifiers).

At block 402, the data analysis subsystem 402 analyzes the gaming session data associated with a unique identifier (e.g., the unique identifier generated by the method 200 of FIG. 2). In some examples, the data analysis subsystem 402 is configured to evaluate the gaming session data with reference to prior gaming session data associated with the same unique identifier to identify trends, anomalies, increased risk taking, or the like. In some examples, the data analysis subsystem 402 analyzes behavioral patterns associated with the unique identifier. For example, the data analysis subsystem 402 may be trained to recognize specific behavioral patterns in the gaming session data (or across historical gaming session data). In some examples, the data analysis subsystem 402 may receive behavioral patterns of interest from a third-party (e.g., a government or regulatory agency). In some examples, the behavioral patterns are representative of transaction amounts (e.g., dollar amounts). In some examples, the behavioral patterns are representative of specific actions. For example, the data analysis subsystem 402 may analyze (and flag) transactions patterns that indicate irregular transactional volumes, suspicious or banned IP address sources, bets placed on foreign events, or any other type of mismatch from expected or permitted behavior associated with the user accounts of the respective gaming platforms.

Similarly, the data analysis subsystem 402 may evaluate the gambling session data (or attributes of the data) with reference to one or more thresholds. Such thresholds may include a maximum number of transactions, a maximum loss amount, a maximum number of deposits, or any combination thereof. As described above, the gaming session data can include pre-existing user-specific or platform-specific limits (or restrictions) that may be applied as thresholds. In some examples, the data analysis subsystem 402 receives one or more thresholds of interest from a third-party (e.g., a government or regulatory agency). For example, the gaming platform user may have placed themselves on gaming exclusion list to address a gambling problem or to automatically limit gambling. In some examples, a threshold applies to an individual gambling platform (e.g., a total amount deposited on a single platform). In some examples, a threshold applies to multiple (or all) gambling platforms. For example, if a global threshold of $1000 is in place, and the user already has $500 in outstanding transactions on a first platform (e.g., DraftKings), the threshold will be triggered if the user bets a cumulative amount over $500 on other platforms.

At block 404, the data analysis subsystem 402 determines at least one limit setting for the unique identifier. The limit settings may include deposit limits, spend limits, loss limits, time limits, cool-off periods, or any combination thereof. In some examples, the limit settings are determined based on a specific behavioral pattern detected in association with the unique identifier. In some examples, the limit settings are determined based on a deviation from an expected behavioral pattern. In some examples, the limit settings are determined based on the gambling data session associated with the unique identifier crossing one or more thresholds.

At block 406, the at least one limit setting is transmitted (or otherwise provided) to at least one gaming platform of the plurality of gaming platforms. In one example, the at least one limit setting is transmitted from the data analysis subsystem 102 to the gaming platform(s) 106 via the data bridge 104. For example, the data analysis subsystem 102 can assign the limit settings to the unique identifier. In some examples, the data analysis subsystem 102 may report the limit setting to a third-party (e.g., by referencing the unique identifier). Next, the data analysis subsystem 102 links the limit setting to the hashed identity information corresponding to the unique identifier. In other words, the data analysis subsystem 102 may reference a database (or lookup table) that contains the relationship between the original hashed identity information received from the data bridge 104 and the unique identifier created by the data analysis subsystem 102. In some examples, the data analysis subsystem 102 is configured to perform a reverse hash function using the second security string to recover the hashed identity information.

The data analysis subsystem 102 can relay the limit settings and hashed identity information to the data bridge 104. The data bridge 104 then links the limit setting to the identity information (i.e., PII) corresponding to the hashed identify information. In other words, the data bridge 104 may reference a database (or lookup table) that contains the relationship between the original identity information received from the plurality of gaming platforms 106 and the hashed identity information created by the data bridge 104. In some examples, the data bridge 104 is configured to perform a reverse hash function using the first security string to recover the identity information.

The data bridge 104 can then transmit the limit settings and identity information (i.e., PII) to at least one platform of the plurality of gaming platforms 106. In some examples, the limit settings are transmitted to each platform of the plurality of gaming platforms 106. In some examples, the limit settings are transmitted to a portion of the plurality of gaming platforms 106. For example, if a cool-off period is being applied to a particular casino game (e.g., slots), then the limit settings may only be transmitted to the gaming platforms that offer the casino game. In some cases, the limit settings may be jurisdiction-specific. As such, the limit settings may only be transmitted to the gaming platforms that are authorized to operate within the relevant jurisdiction. By providing limit settings in this manner, the limit settings may be automatically applied by the gaming platforms while maintaining confidentiality between the determination of the limit settings and the effected users.

In addition to determining limit settings, the data analysis subsystem 102 may flag unique identifiers that demonstrate “problem gambling” behavior. For example, the data analysis subsystem 102 may detect a pattern that indicates problem gambling behavior. This information may be relayed to the gaming platforms 106 via the data bridge 104. In some examples, individual users may be automatically contacted by gambling resource centers. Likewise, the data analysis subsystem 102 may flag unique identifiers that demonstrate “illegal” or “suspicious” activity. For example, the data analysis subsystem 102 may detect a pattern that indicates illegal gambling activity (e.g., money laundering, fraud, sports tampering, or the like). This information may be relayed to third-parties for further investigation. In some examples, the gaming platforms 106 are automatically notified of the users associated with the illegal activity.

Safeguarding of the identification data may be implemented in different ways, such as via data obfuscation techniques and/or data encryption. Data obfuscation, for example, is a process of replacing sensitive information with data that looks like real production information, making it useless to malicious actors. It may be used in test or development environments where developers and testers need realistic data to build and test software, but is also implementable in production systems to avoid disclosure of the real data. Examples of data obfuscation may be randomizing data fields, replacing data from a list of similar data (e.g, names with different names selected from a large name list), removing data, such as location information, and the like. Data encryption is the process of transforming readable plaintext into unreadable ciphertext to mask sensitive information from unauthorized users. Encryption works by using algorithms to scramble data into an indecipherable format, which can only be unscrambled by authorized parties with the right decryption key. Examples of data encryption may include hashing algorithms, advanced encryption standard algorithms, elliptic curve cryptography algorithms, blowfish encryption, RSA encryption, or the like. A difference between the two is that obfuscation hides the purpose or meaning of data without changing the data itself, while encryption completely changes the contents of data, making it unreadable without a specific key or algorithm.

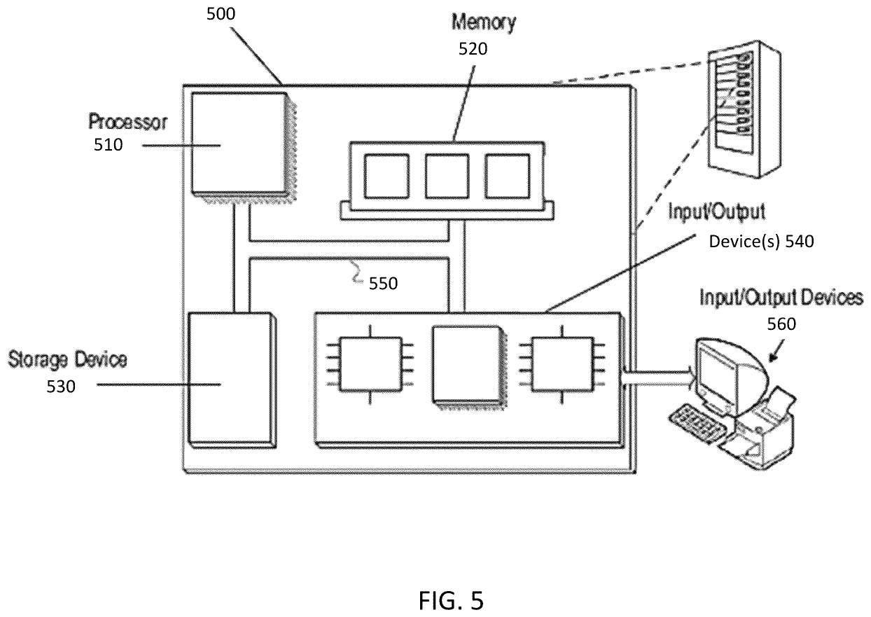

FIG. 5 is a block diagram of an example computer system 500 that may be used in implementing the systems and methods described herein. General-purpose computers, network appliances, mobile devices, or other electronic systems may also include at least portions of the system 500. The system 500 includes a processor 510, a memory 520, a storage device 530, and an input/output device 540. Each of the components 510, 520, 530, and 540 may be interconnected, for example, using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a non-volatile memory unit. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, or the like). The input/output device(s) 540 provides input/output operations for the system 500. In some implementations, the input/output device 540 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, such as a server farm or a set of widely distributed servers, or may be implemented in a single computing device.

Although an example processing system has been described in FIG. 5, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment.

A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media, and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

As described above, systems and methods for providing multi-factor cross platform transaction identification are provided herein. In at least one embodiment, a gaming analysis system includes a data bridge configured to communicate with a plurality of gaming platforms and a data analysis subsystem configured to communicate with the data bridge. The data bridge receives gaming session data from at least one gaming platform of the plurality of gaming platforms. In some examples, the gaming session data including identity information of a user associated with the gaming session data. The data analysis subsystem transmits a first security string to the data bridge and the data bridge hashes the identity information of the gaming session data with the first security string to create hashed identity information. Then, the data bridge transmits the hashed identity information and the gaming session data to the data analysis subsystem and the data analysis subsystem hashes the hashed identity information of the gaming session data with a second security string to create a unique identifier. In some examples, the unique identifier is used to analyze and monitor gambling behavior in a secure, confidential manner.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law. As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is 5 to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A method for multi-factor cross platform transaction identification, comprising:
communicating, via a data bridge, with a plurality of gaming platforms;
communicating, via the data bridge, with a data analysis subsystem;
receiving, via the data bridge, gaming session data from at least one gaming platform of the plurality of gaming platforms, the gaming session data including identity information of a user associated with the gaming session data;
transmitting, via the data analysis subsystem, a first security string to the data bridge;
safeguarding the identity information of the user of the gaming session data, via the data bridge, using the first security string to create safeguarded identity information;
transmitting, via the data bridge, the safeguarded identity information and the gaming session data to the data analysis subsystem; and
further safeguarding, via the data analysis subsystem, the safeguarded identity information of the gaming session data using a second security string to create a unique identifier.

2. The method of claim 1, wherein safeguarding comprises:
obfuscating the identity information.

3. The method of claim 1, wherein safeguarding comprises:
encrypting the identity information.

4. The method of claim 1, wherein the first security string is a random security string and the second security string is a random security string, and the first security string is different from the second security string.

5. The method of claim 1, wherein the first security string is a first secret key and the second security string is a second security key, and the first security string is different from the second security string.

6. The method of claim 1, further comprising:
analyzing, via the data analysis subsystem, the gaming session data associated with the unique identifier; and
determining, via the data analysis subsystem, at least one limit setting for the unique identifier.

7. The method of claim 6, further comprising:
transmitting the at least one limit setting to at least one gaming platform of the plurality of gaming platforms.

8. The method of claim 6, further comprising:
transmitting the at least one limit setting to each gaming platform of the plurality of gaming platforms.

9. The method of claim 6, wherein the at least one limit setting includes a deposit limit, a spend limit, a loss limit, a time limit, a cool-off period, or any combination thereof for gaming platform accounts of the user associated with the unique identifier.

10. The method of claim 6, wherein analyzing the gaming session data associated with the unique identifier includes evaluating the gaming session data to prior gaming session data associated with the unique identifier to identify trends, anomalies, and/or increased risk taking.

11. The method of claim 6, wherein analyzing the gaming session data associated with the unique identifier incudes detecting a behavioral pattern associated with the unique identifier.

12. The method of claim 6, wherein analyzing the gaming session data associated with the unique identifier incudes comparing at least a portion of the gaming session data to at least one threshold.

13. The method of claim 1, wherein the plurality of gaming platforms includes online gambling platforms.

14. A system for providing multi-factor cross platform transaction identification protection and transaction analysis, comprising:
a data bridge configured to communicate with a plurality of gaming platforms;
a data analysis subsystem configured to communicate with the data bridge;
at least one memory; and
at least one processing unit for executing computer-executable instructions stored in the memory, wherein the instructions, when executed, instruct the at least one processing unit to:
receive, via the data bridge subsystem, gaming session data from at least one gaming platform of the plurality of gaming platforms, the gaming session data including identity information of a user associated with the gaming session data;
transmit, via the data analysis subsystem, a first security string to the data bridge;
safeguard, via the data bridge, the identity information of the gaming session data with the first security string to create safeguarded identity information;
transmit, via the data bridge, the safeguarded identity information, and the gaming session data to the data analysis subsystem; and
further safeguard, via the data analysis subsystem, the safeguarded identity information of the gaming session data with a second security string to create a unique identifier.

15. The system of claim 14, wherein the processing unit, when safeguarding the identity information, is operable to:
encrypt the identity information.

16. The system of claim 14, wherein the processing unit, when safeguarding the identity information, is operable to:
obfuscate the identity information.

17. A method for providing cross platform transaction limit settings, comprising:
receiving gaming session data from at least one gaming platform of a plurality of gaming platforms, the gaming session data including identity information of a user associated with the gaming session data;
retrieving a universal limit setting associated with the user based on the identity information;
comparing the gaming session data to the universal limit setting; and
determining an adjusted limit setting based on at least one result of the comparison.

18. The method of claim 13, wherein the adjusted limit setting corresponds to a difference between the universal limit setting and at least one amount included in the gaming session data.

19. The method of claim 13, further comprising:
providing the adjusted limit setting to each gaming platform of the plurality of gaming platforms.
